(19) United States
(12) Patent Application Publication
(10) Pub. No.: US 2021/0014710 A1
(43) Pub. Date: Jan. 14, 2021

(54) WiFi Network Monitoring Smart Sensor and Network Early Warning Platform

(71) Applicant: MobileComm Ventures LLC, Richardson, TX (US)

(72) Inventor: C.G. Venkatesh Raju, Richardson, TX (US)

(21) Appl. No.: 16/926,504

(22) Filed: Jul. 10, 2020

Related U.S. Application Data
(60) Provisional application No. 62/872,683, filed on Jul. 10, 2019.

(51) Int. Cl. H04W 24/08; H04W 12/06; H04L 29/06; H04W 4/38; H04L 12/24; H04L 12/26

(52) U.S. Cl. CPC H04W 24/08; H04W 12/06; H04L 63/08; G16Y 10/75; H04L 41/0686; H04L 43/045; H04L 43/50; H04W 4/38

(57) ABSTRACT

A smart WiFi system includes a smart sensor which has a WiFi interface configured to communicate data via a WiFi network, a LTE interface configured to communicate data via a LTE network, an IP interface configured to communicate data via an IP network, a fallback module configured to detect failure in one of the WiFi, LTE, and IP networks and switch data communication to a viable network, an RF scanner configured to detect and identify RF signals in the surrounding environment for assessment of network quality and operating status, a test logic module configured to administer a plurality of tests designed to test the operations of the networks and network components, and a logging module configured to compile a record of received sensor data, network data, and network operating parameters and storing the data in a database. The system further includes a smart analytic platform that is in communication with the smart sensor. The smart analytic platform includes a data analytic module configured to analyze network data to determine network operating parameters and issue early warning in response to network alarms, and a dashboard module configured to present the sensor data, network data, data related to network operating parameters, and early warnings on a display screen.

### RELATED APPLICATION

This application claims the benefit of U.S. Provisional Application No. 62/872,683 filed Jul. 10, 2019, which is incorporated herein in its entirety.

### FIELD

The present disclosure primarily relates to computer networks and in particular to a WiFi network monitoring smart sensor and network early warning platform with fail-safe connectivity and network traffic monitoring capabilities at the edges of the network.

### BACKGROUND

In computer networking, a wireless access point (WAP), or more generally an access point (AP), is a networking hardware device that allows other WiFi devices to connect to a wired network. The AP typically connects to a router (via a wired connection or network) as a standalone device, but it can also be an integral component of the router itself. An AP connects directly to a wired local area network, typically Ethernet, and the AP then provides wireless connections to other devices so that these devices may send/receive data using that wired connection. APs support the connection of multiple wireless devices through their single wired connection.

It is generally recommended that one IEEE 802.11 AP should have, at a maximum, 10-25 clients. However, the actual maximum number of clients that can be supported by one AP can vary significantly depending on several factors, such as type of APs in use, density of client environment, desired client throughput, the type of data being transmitted, etc.

### DESCRIPTION OF THE DRAWINGS

FIG. 1 is a simplified block diagram of an embodiment of a smart network monitoring sensor according to the teachings of the present disclosure;

FIG. 2 is a simplified block diagram of an example distributed architecture of the smart network early warning system according to the teachings of the present disclosure;

FIG. 3 is a simplified block diagram of an embodiment of a network early warning platform according to the teachings of the present disclosure;

FIGS. 4-7 are simplified data flow diagrams depicting data flow from data sources to the front end (GUI and web portal) and the back end (database) according to the teachings of the present disclosure;

FIG. 8 is a simplified block diagram of an embodiment of a data logging process according to the teachings of the present disclosure;

FIGS. 9 and 10 are simplified log data flow diagrams depicting data flow from data sources to the front end (GUI and web portal) and the back end (database) according to the teachings of the present disclosure;

FIG. 11 is a simplified block diagram of a web portal library according to the teachings of the present disclosure; and

FIG. 12 is a simplified block diagram of a core services subsystem according to the teachings of the present disclosure.

### DETAILED DESCRIPTION

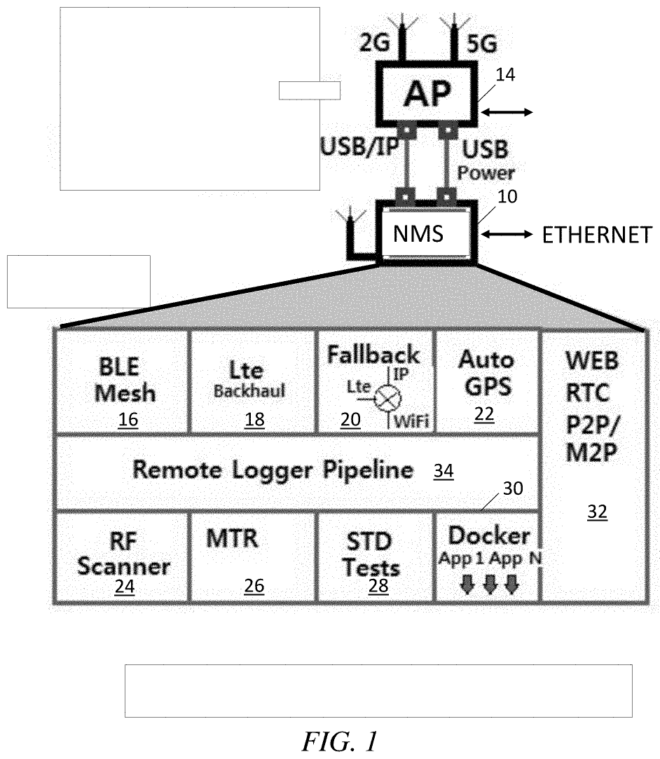

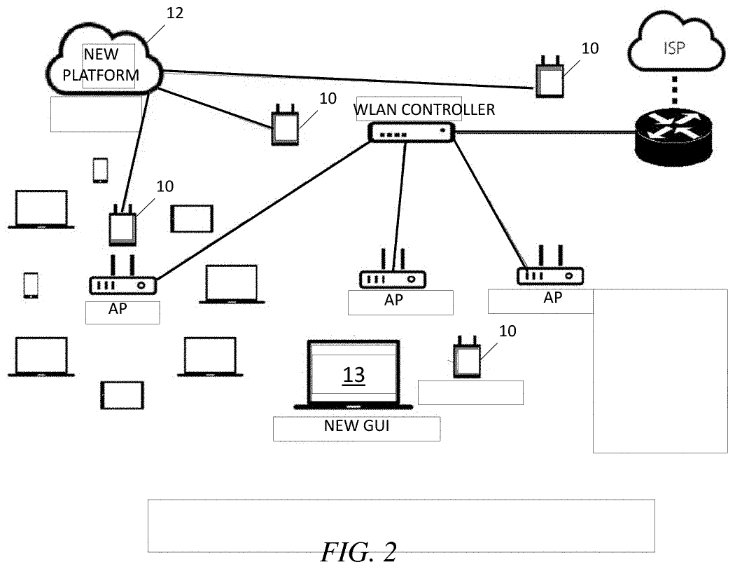

Many organizations and companies rely on WiFi to transmit mission-critical data and conduct business. Referring to FIGS. 1 and 2, the network monitoring sensor (NMS or smart access point) 10 and the associated cloud-based wireless network early warning (NEW) platform 12 described herein enable continuous monitoring and testing of the wireless network so that performance issues are spotted early and optimal network functionality is maintained to enable maximum connectivity. The NMS 10 can be configured to run tests across sensors and other network hosts. The automated tests can deliver real-time streaming data about network and application performance, enabling the NEW platform 12 to detect and identify problems even before the end-users do. The NMS 10 is a compact wireless device that can be plugged into any electrical outlet and operate in a stand-alone mode or piggybacked onto an existing access point. The NMS 10 is a self-contained and compact unit utilizing Power over Ethernet (PoE) with a battery backup. The NMS 10 can execute active testing, cyclic end-user synthetic test traffic (Layers 1-7), perform comprehensive passive analysis (Layers 1-2) as well as 2.4 GHz and 5 GHz spectrum analysis. These tests can be defined in a custom automated/on-demand group-based test profile that can include communication with the premises and cloud servers. The NMS 10 is able to instantly recognize and identify devices, buildings, floors, stores or campuses that are out of compliance with service level targets for WiFi performance, and take proactive and corrective action before any user ever notices or complains. The NEW platform 12 and one or more NMS 10 and a graphical user interface (front end) 13 may hereinafter referred to as a NEW system.

The NMS 10 and NEW platform 12 can be used to monitor devices that connect to the WiFi as guests, devices that come near the guest WiFi, and guest WiFi log-ins. The NMS 10 and NEW platform 12 can be used to gain important insight into customer behavior by tracking visitor count and dwell time, recognize and keep track of new versus return visitors, and see visitor demographic information. From this information, a company may determine, e.g., whether a new marketing campaign is bringing in primarily new visitors or return customers, staffing needs at various times throughout the day, how long customers are spending time on the premises, and locations onsite where customers spend the most time, etc.

The NMS 10 is uniquely designed to measure wireless network connectivity and the quality of the end-user experience on WiFi networks. Referring to FIG. 1, the NMS 10 may be coupled to an existing on-premises AP 14 via USB ports. An exemplary embodiment of the NMS 10 includes the following components:

BLE (Bluetooth Low Energy) Mesh module 16—to enable communication via BLE. A BLE scanner that is part of the BLE mesh module 16 is used to discover Bluetooth devices, and provide detailed information about these devices, including device name, signal strength (RSSI), supported services, battery level, etc.

LTE Backhaul module 18—to enable communication on the LTE network. Capable of parallel LTE scanning and PPP mode. Unlike typical networks like ethernet and WiFi, LTE is handy and mobile network capable of connecting rural areas where WiFi can't extend. This point-to-point protocol has high durability and better transfer rates.

IP, LTE, WiFi Fallback module 20—to enable communication backup using one or more of these communication channels in case of failure in others. This module detects failover and performs load balancing function automatically. As the device is equipped with three modes of networks (IP, LTE, WiFi), it is capable of switching over alternate networks, when any interface is down. This is achieved by a daemon running in the background that serves the purpose of monitoring as well as switching networks. In case of a failure, termination of a system or a network module, the subsequent function is routed to a WAN connection that is running. Multi-WAN Failover is the ability to move over to other active WAN lines in case of a failure of any of the WAN lines regardless of the service provider. The NMS sensor is equipped with the trending multi-WAN support. The device is capable of connecting through three media, such as wire, wireless, mobile, i.e., Ethernet, WiFi, and LTE. A robust daemon monitors health status of these interfaces in the device. In case of any WAN blackout, the algorithm is smart enough to make decisions and switchover to alternate available internet sources. It also supports USB dongles that provide plug-and-connect compatibility.

Auto GPS (Global Positioning System) module 22—ability to receive GPS satellite signals and derive an operating clock signal from the GPS clock signal.

RF Scanner module 24—passive and active RF scanning functions of multiple Wi-Fi (2G&5G), BLE, and LTE links. Passive and active RF scanning functionality is provided by separate dedicated radios that are capable of monitoring WiFi. Passive RF scanning includes operating in “promiscuous” mode and passively collect all the frames/packets and assess and analyze over the air quality of service; wireless edge analytics: validate over the air capacity and channel quality assessment, where the required key performance indicators include AP RSSI, SNR, utilization per SSID, packet loss, management frame consumption analytics per data rate, analyze impact of low rate management/control frame data rate; wireless quality assessment—required key performance indicators include Tx/Rx failure between AP and client; air time utilization (Ent. SSID vs. neighbor WiFi vs. interferer per area/zone).

Active RF scanning functionality includes air quality and performance validation using multi-level MCS data frame; find optimal data rate per NMS location and adjust AP coverage heat map; location calibration probe—use NMS as self-location calibrator and send burst of probe response frame to upon request; RF stat like information during active sensor testing; required key performance indicator includes Tx packet loss per MCS, optimal MCS that shows zero packet loss during 1 MB data transmission.

The LTE scan gives complete parameters including neighboring networks nearby including their location ID, cell ID, and signal strength. The LTE scan gives in-depth analysis of nearby mobile networks. The LTE scanner includes a “narrowband RSSI” measurement that measures the energy in a bandwidth usually set equal to the channel raster for the technology in question. For LTE, the channel raster is 100 kHz, so a NB RSSI measurement measures 100 kHz bandwidths, spaced 100 kHz apart. The LTE scan can be viewed as a bar chart that shows a) LTE base station channel occupancy, and b) interfering signals. If either is found, then appropriate secondary scans may be created, either an LTE signal scan for a base station, or a spectrum analysis scan for an unknown interfering signal.

MTR (Matt's TraceRoute) 26—a computer program which combines the functions of the traceroute and ping programs in one network diagnostic tool. MTR probes routers on the route path by limiting the number of hops individual packets may traverse, and listening to responses of their expiry. It regularly repeats this process, usually once per second, and keeps track of the response times of the hops along the path.

The WiFi data is analyzed within the NMS 10 by a standard tester module 28 and the data and results are stored in the cloud. Some of the key performance indicators that are measured and tracked continually by the NMS include:

Throughput

Packet loss

Latency

Jitter

Voice quality (MOS Score)

Success rates

Retry rates, detailed onboarding failure reason

Beacon availability

Airtime utilization

Channel utilization

Onboarding

Client traffic streaming

Application docker module 30—enable hosting of third part apps to perform various functions.

Web RTC P2P/M2P 32—web real-time communications peer-to-peer/machine-to-people

Remote Logger Pipeline 34—all captured/collected network data are transmitted to and stored in the cloud in a remote server. The logs store overall device detailed view from bootlogs to cloud server attachment, which can be fed to big data mechanism for further analysis and error report and device behavior predictions.

The NMS 10 may have a form factor as a module that can be plugged into an existing deployed enterprise AP 14 and can start operating as a network sensor seamlessly and stream synthetic network test data on a real-time basis to the cloud. It is a combo unit HW comprises of ARM Cortex-A53 1.4 GHz, 1 GB SRAM, with 64 GB expandable flash and runs on customized openWRT embedded Linux sensor agent, which is a master-python process that governs the standard-tests module and covers the overall standard networking testing suite. The following tests are available on-demand at any time:

DNS

FTP

TFTP

Mail server Test

Ping Test

Radius Test

Speed Test

SSH Test

Webserver Test

iPref2/iPref3 Test

Telnet Test

MTR (Matt's TraceRoute) Test

Site reachability Test

IPSLA (MTTR)

HTTP/HTTPS profiling Test

SSL certs Test

REST/SOAP/MqTT bridge Test

Syslog Test

Firewall Test

Load balancer Test

Web Authentication Test

Wired link throughput Test

Backhaul hidden SSID Test

Dedicated Radio Test

Client stickiness Test

Client Onboarding Test

DHCP v4/v6 Test

WiFi (WEP, WPA, WPA2, WPA3) Security Test

Wireless PCI DSS POS compliance Test

NAT/PAT Test

WAN uplink Test

Deep Packet Inspection Probe passively captures packets at high throughput, detecting applications, parsing protocols, and extracting traffic metadata. Traffic metadata is used to contextualize alerts, which reduces the number of false positives, and allows analysts to carry out more efficient investigations, resulting in faster remediation. This Probe only stores traffic metadata (sender, receiver, device type, file type, etc.), discarding irrelevant content, such as video. Forensic storage is reduced by up to 150× compared to full packet capture. Delivered as a software component, this Probe can be used in virtualized, physical and hybrid infrastructures.

DISCOVERY+PROVISIONING+SECURE ONBOARDING

An unique security certificate for the device will be generated at the time of manufacture/build-process using (WIRED+WIRELESS+IMEI-number) combination and it can be stored in the root-permission/etc/storage/certs/dev-certs in encrypted format.

Verify if the sensor is active and collect input to form connectivity policies, the enterprise should remain in control, but the service is seamless.

Device discovery phase happens based on the interfaces wired/wireless and IPv4 address is assigned to it; State machine based discovery and onboarding process

Once deployed, the security policy and certificate has to be triggered, and a replacement is delivered over the air[WIFI/LTE]/wired interface.

The automated process is entirely zero-touch.

The device private keys, certificates and firmware validation keys are securely stored in protected storage implemented by Device Management Client. The protected storage can secure the data in external and internal non-volatile memory serving as a protected root-of-trust in the device. For increased security, the root-of-trust capabilities supported by Arm processors.

To connect to MCPS Device Management each sensor device must have a unique cryptographic credential. This unique credential is used to authenticate devices, generate session encryption keys and authorize device access to various system services. The device cryptographic credential is stored securely to protect data that moves between the device and the server, and to protect the device management service itself from unauthorized access.

Each sensor device must be configured with the correct server and connection parameters to identify, connect to and authenticate the Device Management server. Device Management Provision supports industry-standard X.509 certificates. These certificates facilitate mutual authentication and establishment of encrypted DTLS or TLS sessions between devices and the device management server.

Overall the NMS 10 governs:
End-to-end secure connectivity
Device Identification and mutual authentication
Certificate Management
Disaster recovery
Device decommission and reassignment

An RF scanner functionality of the NMS aggregates the overall wireless RF stats of WiFi (2G and 5G), BLE (Bluetooth Low Energy), LTE link quality. Metrics and streams scanned results to the cloud as lengthy JSON and streams PCAP files. The RF scanner can be triggered specific to certain radio frequencies, such as WiFi only, BLE only, LTE only, as well as a combined scan.

Sensor generated 3D QR-Code should be capable of being scanned by MCPS provisioning cognitive visualization-app that should run the protocol the Device Provisioning Protocol (DPP). The user establishes a secure connection to an sensor device by scanning the sensor-specific QR code. This prompts the protocol to run and automatically provisions the enrollee with the credentials needed to access the network.

Android AR-Canvas app upon gleam-on Sensor will tile-out current trending patterns and predictive patterns. (Upon scanning the QR code from dashboard, app should take control and should be able to reveal insights going on that wifi-SENSOR)

The system is capable of GRPC for file transfers to stream files to the cloud for storage and safekeeping. The stored data may be encrypted.

The NMS 10 may include a quad core soc integrated with mic, cam, three radio scanners, and GPS system which itself makes the system versatile and multipurpose. As the device contains several daemons and on demand services, to maintain the integrity and robustness of the device, the kernel is optimized for better performance and robustness. Further, most of the functions are packed into kernel for optimum and unmatched performance with less power consumption. sensor integrated cam-sensor can do real time steaming of video and from its stats it can deliver video quality metrics, below architecture shows the overall sensor-cam metrics processing pipeline. The NMS sensor 10 includes:

Multiple power options (PoE, Micro USB)

10 Hours battery backup

WWI 802.11ac (Wave2) 3T3R MIMO antenna

BLE 5.0 MESH support

3G/4G LTE, LoRaWAN backhaul

Inbuilt GPS (Enables outdoor MESH-Sensor deployments easy, Fast-NTP Syncup; seamless automatic onboarding upon power-on)

Memory (32 GB, 64 GB, 512 GB, 2 TB), 1 GB-4 GB RAM

Runs on openWRT

Integrated camera (variable lens Options ranging from 2.0 mm to 5.7 mm supporting heights from 2.4 m to 20 m (8 ft up to 65 ft))

USB 3.0 bridge enables Plug ‘n’ Play/Hot plug support (Enterprise Sensor MESH-deployment sensor can be turned on to carter AI @ EDGE [Not relying on the connection with the cloud] WAN link not required)

Secure data-logging retention 60+ days (configurable)

The Network Early Warning (NEW) Platform 12 features include:

Secure MqTT+RESTFUL bridge, gRPC streaming support for live data monitoring and troubleshooting (Active/Passive RF-Network spectrum analysis)

On-demand based containerized application performance synthetic testing (POS, MEDICARE, Factory-Floor Logistics, Hospitals, Libraries, Schools/Universities, Malls, Transport sector, etc.)

Wireless Backhaul based on-boarding, Hidden SSID support, Wireless link quality monitoring

Deep insights on to Hostapd, Monitor mode state-machine visualizations

Security settings (RADIUS Server, AAA), client onboard failures and its RCA, soft-spot markers prone failures

Automatic Device Classification

Distributed/Sprinkled NMS sensors does automated detection, notification, mitigation and provides detailed and actionable insights through MPCS NEW platform.

NEW machine-learning/AI platform incognito engine always keeps monitoring current trends and EYE view depicts predictive trends; Auto-Action mode enables to self-govern the Network

Automated/Scheduled synthetic test suite (Combination of tests such as Connectivity/PING test, Reachability test, Device discovery/Onboarding test, Application tests, Security audit tests, Throughput test, Mail-server monitering, Real-user monitering, SSL-Certs monitering, Real user monitering, Syslog; Cron; Docker monitering, Full-Stack monitoring, WebRTC [P2P, MultiPeer, MOS score], Firewall monitoring)

Instant live/historical wireless network ecosystem visibility made available at the toggle of a button.

Sensor name selection reveals live sensor status page update

Live/History, Replay of remote sensor console logger classified visualization

Batch/Group based test suites can be created and executed in one go

Site reachability test (detailed visibility into the web page life cycle and breakdown of response time from a network perspective like redirection time, DNS resolution time and connection time. Back end and front-end response time such as page rendering, document processing and document downloading time, Apdex score [Gauging USER-Experiences], Waterfall-View view of components loading time)

Multiple-domains of interest reachability/path-visualization can be known in one go.

Advanced sensor features include:

WebRTC Peer2Peer; Multi-peer overcall call quality monitoring (MOS-Score, Jitter, Call-Quality prediction based on WebRTC metrics and gives insights from 750+data points)

RESTFUL+secure MqTT bridge enables to simultaneous communication channels

Camera integrated with the NMS sensor 10 enables video/image analytics along with standard WiFi test analytics

End-to-end link quality monitoring of LAN, WAN (Uplink/Downlinks)

WiFi-Link Quality, -Wired Link Quality, -VLAN config, BLE Link Quality-Distance between Data Gateway and BLE nodes, Star topology, Mesh-Topology detection, Past; Present-BLE running profiles, MAC/IPv6, IPv4 6LoWPAN address, Sensor data transmitted over BLE payload, Two-Way control over BLE command & Control, Profiles changeover (Adv-Beacons, Heartbeat, Sensor control & Monitor), BT-BLE modes switching/toggling, Link Quality monitering during file transfer, High Data Rates (Max Payloads), Energy consumption levels, BLE data upload/Download, MAX Single hop throughput; MIN-Single hop turnaround time, MAX-Throughput on ADV-CH; DATA-CH,BLE (UPLOAD/DOWNLOAD)-Compressed data (Kb/Mb Vs Time), Topology formations over period of time (Single Slave, Multi-slave, Scatternet), Parked node (Nearby master, Slave but not connected), Max Single hop/Multi-hop throughput, (Nodal-distance/Link Quality vs Time), BLE sequence diagram (Association, Onboarding, States, Beaconing, Profiles).

Troubleshooting of Real-Time Application usage between Client-to-Client using real or/and synthetic traffic—NMS sensors can gauge symptoms like: One-Way Audio, Delayed voice, Pixelated Video, the video call won't connect. poor audio or video quality, call disconnects while the video meeting is in session, no audio, video or presentation sharing, NEW platform can roll-in recommendations though its cognitive backbone.

Past, Current, and Predictive trends visualization enable the users to know root cause and can foresee network behavior well in advance.

The NEW platform 12 enables various network tests where the user may configure and test a device in various parameters by running various network tests and compare the results. This platform allows the user to view the live test results and history of the current running tests. User can create and configure a new test suite with multiple tests involved, view the stored test results, altering the stored test configurations and to archive the stored test results (Stop the running tests in a device).

The proposed NEW architecture is a n-tier architecture. The idea is to have a platform which can scale horizontally catering to hundreds of devices. The big difference of this platform over other B2C application is that this application is “Read less Write more, whereas the typical B2C application operates on the “Read More and Write More” basis. The ramification of this is that the platform focuses more on the catering to the data that come into the system, i.e., data that is getting written into the system. This can be validated easily since the plan is to have hundreds of devices across the counties and states. When regular data is coming from these many number of devices then the amount of data that can get accumulated over a period of time can be extremely large and the choice of the database should be such that it can scale horizontally.

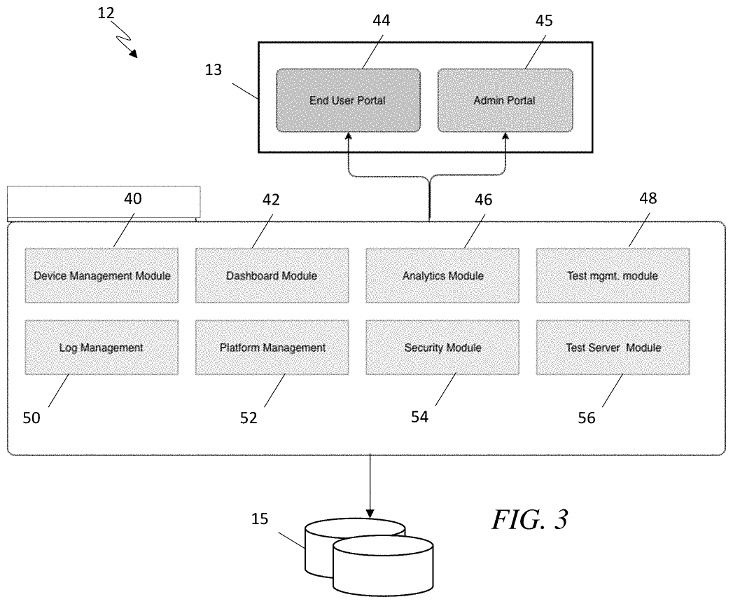

As shown in FIG. 3, the NEW platform 12 is divided into various logical modules so that the various functions can be easily managed and maintained:

The device management module 40 is one of the key modules of the NEW platform 12. The responsibilities of this module include managing the sensor interaction with the platform. One responsibility of the device management module is to manage provisioning and de-provisioning of the device, manage life cycle of the device from the platform. This platform introduces lifecycle management of the device. The platform is responsible for sending START, STOP events to the device. The platform is also responsible for sending CURRENT_STATUS event to the device which will get the heartbeat info of the platform. The advantage of this mechanism is that platform which is now at the controlling aspect can find if the device is reachable at all or if the device's reachability is SLOW. This way the platform can explain why test results are coming slow.

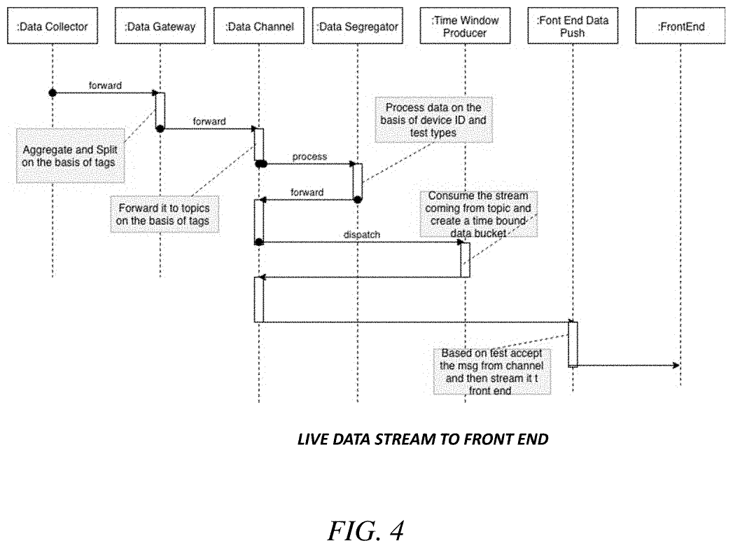

The dashboard logic module 42 is the GUI-centric module of the platform that provide an end user portal 44 and an admin portal 45. The dashboard module 42 is responsible for the visualization of various data points for which the platform is acting as a data sink. As shown in FIG. 4, the dashboard module 42 may be PUSH-based, i.e., the platform will PUSH data to the front end 13 and the dashboard will render the graph at runtime and dynamically. The end user will see near-real time graphs and charts displayed on the screen(s). The dashboard module 42 also has a history option where in the user can see historical “test result” dashboard for a given time interval. After logging into the application, the user will land in dashboard page where user can see several sensor details and test details which are already configured. The dashboard page contains the following segments. Profile Area: On the top right user can find this section, this contains profile information and option to logout; Sensor details section: This section contains a map and pi devices located on the map. The tests can only be triggered on these devices. There is street view option also available to see the street view. On hovering on the device, one will get to see few details like location on device, memory, CPU, etc.; Config Table: This is where all the configured test details appear. On clicking on the eye icon one may see the test results plotted on the screen.

The analytics module 46 gives a more business-like feel to the platform by adding capabilities which are beyond current system. These reports can be generated periodically for based on devices, geography, test types etc. the system should have a canvas like mechanism where the end user can fix the template of the report and the schedule of the report. The crunching of the report will be done based on the scheduled time and a PDF copy will be stored by the engine for consumption. Since these crunching will be entirely at a platform level this will have no ramification on the performance of front end 13. The flow of sequence is as follows:

1. The user sends a request to create a new report (The argument contains the template of the report and the scheduled time).

2. The orchestrator stores the template and scheduled time in the config DB 15. And sends a parallel copy to the reporting engine.

3. The reporting engine (which contains a schedular create the schedule time) to trigger the report creation.

4. On the getting the triggered time event it goes to config DB 15 and picks the meta data.

5. The reporting engine goes to Analytics DB 15 and gets the data it needs to crunch and based on template arranges the data into report.

6. The report in the form of PDF now stores the data in report storage.

The test management module 48 is responsible for maintaining the life cycle of the test suites and data. The meta data of the test and test suites is stored in the Config DB 15 and the data of the test will be stored in the Analytics DB 15. The module 48 is the heart of the entire platform. The module 48 is responsible for PUSHING data to the front end 13 while maintaining a copy in the Analytics DB 15. The module 48 will have pipelines to accept realtime data and to process it and push it accordingly.

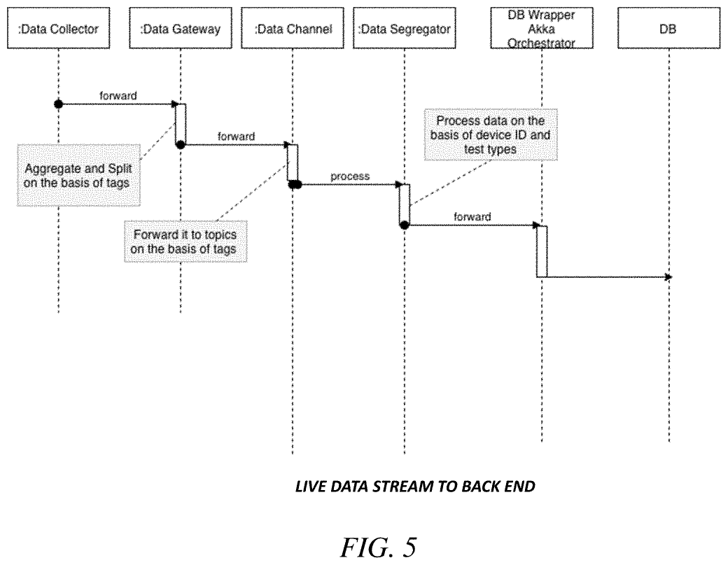

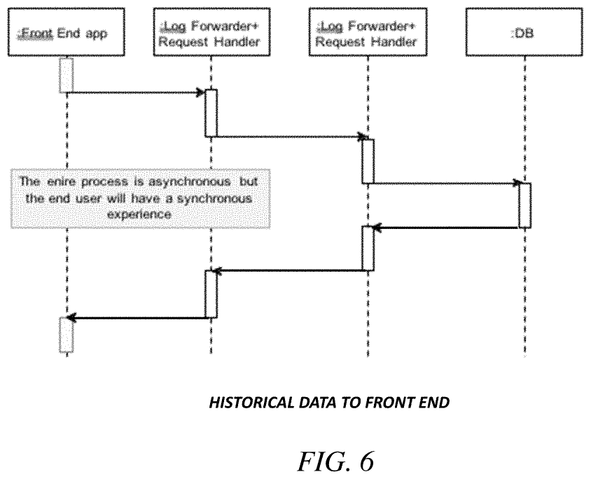

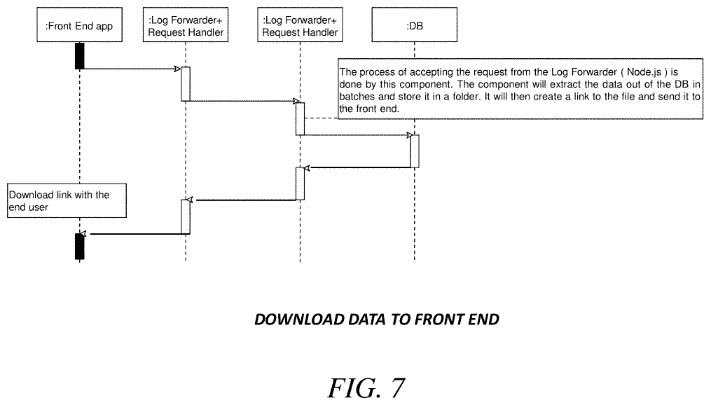

FIG. 4 is a data flow diagram of live data stream from the data collector to the front end 13, and depicts the data streamed to the front end directly from the source, the NMS sensor 10. FIG. 5 is a data flow diagram of live data stream from the data collector to the back end (database(s)) 15. FIG. 6 is a data flow diagram of historical data stream fetched from the database to the front end 15. FIG. 7 is a data flow diagram of download data forwarded to the front end. The system has the capability to display data at the front end in the browser window.

Returning to FIG. 3, the log management module 50 of the NEW platform 12 has the capability to analyze, create visual dashboards for the data flowing from the sensor. Apart from sensor data the platform 12 has the capability to process the logs generated by the NMS sensors 10. A sensor which inherently is a LINUX box is currently used to gather sensor data for various network and web tests. These data are sent to the platform 12 via a web interface, for example. Similarly, log data is also collected by the device and sent to the platform but via a different interface. The Sensor analytics platform of the many interface it uses to communicate with the outside world also has capability to accept or communicate information in “FluentD Forward Protocol Specification.” The design of the log management module 50 is done to align to the architecture of the platform 12, and the entire process is asynchronous to enhance scalability of the platform and for better resource utilization. The design supports multiple sensors. The files will be observed for any changes and when new logs are written to the file and the newly written logs may be sent to the platform for further processing. The design supports multiple files to be observed. The log management module 50 is designed so that the devices can rapidly send data to the platform 12 and the processed data may be sent to two principle consumers of the data, a front end and a database. The front end is a consumer of the data so that logs can be shown at real-time. The database is another consumer of the data so that logs can be stored and historical analysis can be performed (if needed) or the data can be viewed on the basis of time and date criteria.

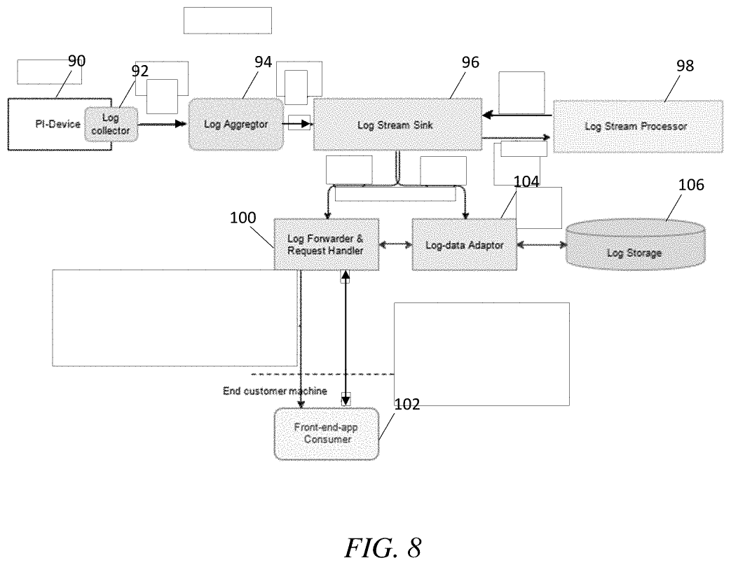

Referring to FIG. 8, the Log Collector component of the log management module 50 is, e.g., a FluentD installation, which is installed in the PI-Device 90 and is responsible for collecting log data as they get written to the log files and streaming to the front end and to the back end (see FIGS. 8-10). The log collector 92 uses a pointer to indicate data already sent so data are not resent. The log aggregator 94 may be, e.g., a FluentD installation that is installed on the Amazon Web Services (AWS) and is responsible of receiving data from all the log collectors 92. Its second responsibility is to forward the data as a stream to log stream sink 96 based on the type of log. The log stream sink component 96 is, for example, a Kafka installation. This component 96 is responsible for collecting data streams based on the type of log. This component 96 also acts as a log stream router. At one point it collects the data from the log aggregator 94 and at the same time it forwards the stream to a log stream processor 98. It also reads the processed data from log stream processor 98 and channels them to appropriate topics so the consumers listening to them can consume them. The log stream processor component 98 is, for example, a Flink installation. This component 98 is responsible for reading, segregating, and channelizing log data. This component 98 is responsible for any application of logic on data or complex event processing. The log forwarder & request handler 100 is, for example, a Node.js installation. This component 100 has multiple responsibilities. It is responsible for getting the streaming data and pushing it to the front-end-app consumer 102. It also mediates the request from the front end for historical data and passes it to the log-data adaptor 104 and returns the response to the front-end-app consumer 102. The log forwarder 100 will massage the data and bring it to a form so that front-end-app consumer does not consume a lot of CPU resources of the end user's machine. Moreover, it will also attach markers to color the data streams forwarded to the front-end-app consumer 102. This way the end user will see colored logs based on the log level. The front-end-app consumer component 102 is the customer-facing component and is implemented in React.js, for example. The component 102 is responsible for managing customer generated events for showing historical data and displaying the stream data from back end components. The end user can select the type of log/logs he wants to see along with a choice to choose the log level also. The end user can also choose to see number of lines of message in the console. The log-data adaptor module 104 is a wrapper over the database 106 and is implemented in, for example, Akka. This component 104 is responsible for storing stream log data into the DB 106 and is also responsible for fetching appropriate data back from the DB 106 based on the user events.

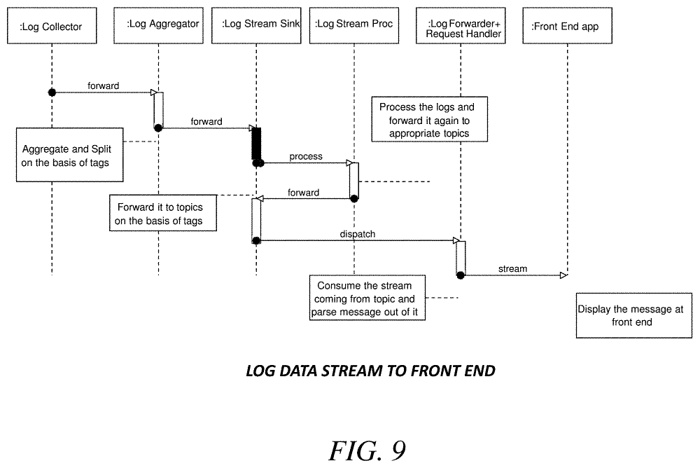

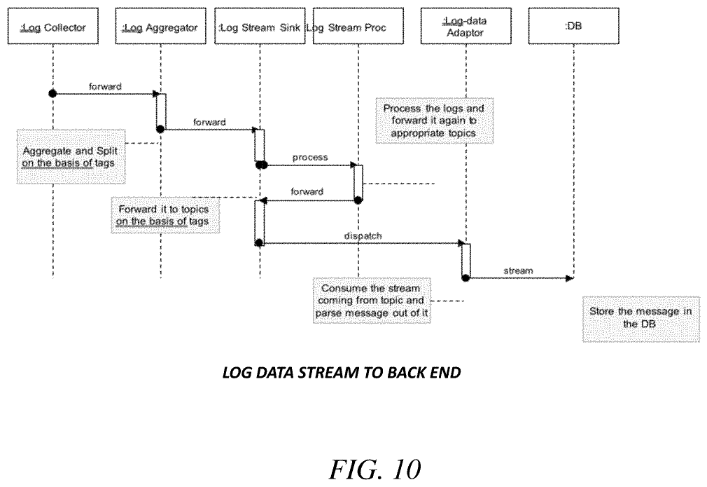

FIG. 9 is a data flow diagram that depicts live data streaming to the front end directly from the source, i.e., the Pi device, by the log collector. FIG. 10 is a data flow diagram that depicts the streaming the log data to the database to ensure there is no data loss.

Returning to FIG. 3, the platform management module 52 is responsible for upkeep of the platform by performing cleansing processes. Apart from that this module also has services to create resources like topics for data flow, and delete topics when the device is de-provisioned. This is also important for maintaining the platform when it goes in the cluster mode and any dependency can be resolved by calling services in this module. The activities performed by this module include:

Clean the logs generated by the platform

Scripts/Service to create channels for new devices

Scripts/Service to delete channels for new devices

Scripts/Service to create actors for new devices

Scripts/Service to delete actors for new devices

Scripts/Service to manage the health and life cycle for the servers (software) used in platform

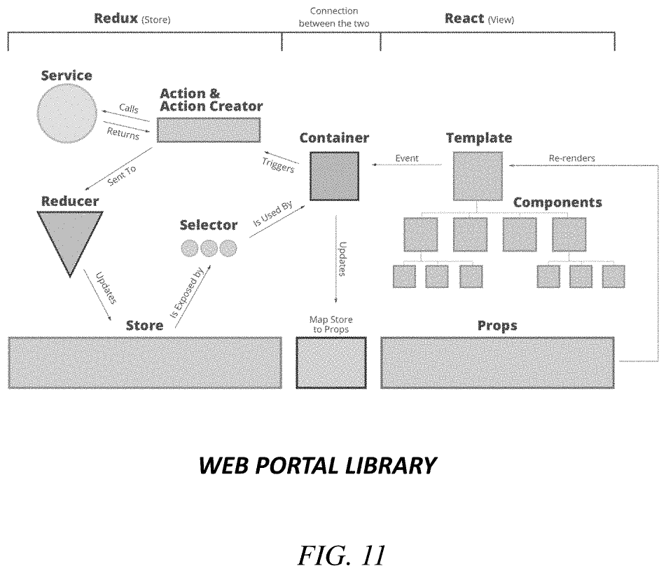

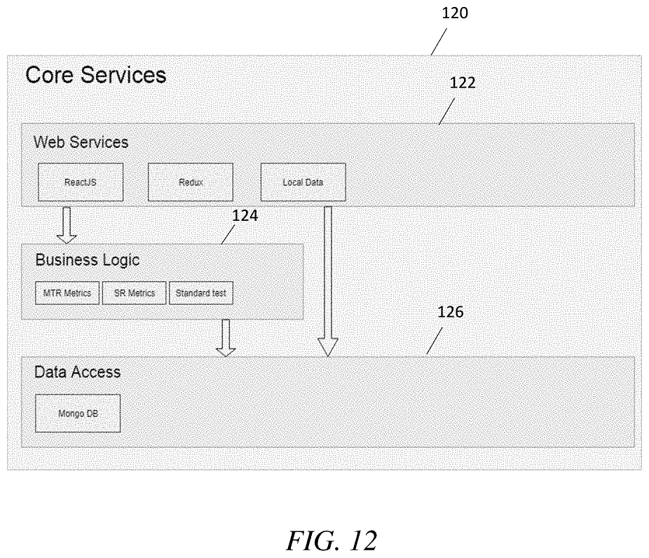

Referring to FIG. 3, the NMS 10 also includes a security module 54. The NEW platform 12 abides by the security policies provided by the AWS environment. Moreover, the communication between front end and the platform (data gateway or front-end data push) is done via https. A simplistic representation can be done via viewing the entire platform as black box and the only way the communication can take place is via https. The security module 54 consists of all the components that are deployed on the AWS server for web-based application functionality. The NEW platform 12 interacts with the core services (see FIG. 12) and portal & workflow subsystems. The web portal utilizes components that are included in the common library (see FIG. 11).

The core services subsystem 120 (FIG. 12) mainly consists of the server-side business logic required for the network assurance monitoring subsystem. This subsystem also consists of all the functionality that is required to handle a document after it leaves the workflow subsystem before the document is sent to the distribution sub-system. The core services subsystem 120 consists of these layers: web services 122, business logic 124, and data access 126. The web services layer 122 provides a set of method wrappers. The web services do not implement any business or processing logic. The web services layer 122 handles authentication, logging of exceptions, and the re-throwing custom exceptions. The web service methods either call a data access object or a business logic component. The web services accept and return custom entity objects or arrays of custom entity objects. The business logic layer 124 provides components for use in cases where there is complicated business logic, or data from more than one data source is involved. The defined business logic components are Apdex score calculation, page insights metrics, etc. The front end application uses the pull-based methodology to access the database using flask and python. This subsystem consists of all the components required to manage the NEW portal system, business logic to manage the document state and document metadata, business logic to manage the workflow of the document. This sub system also handles the functionality required to implement Admin and reporting functionality.

My traceroute, originally named Matt's traceroute (MTR) in the business logic layer 124, is a computer program which combines the functions of the traceroute and ping programs in one network diagnostic tool. MTR probes routers on the route path by limiting the number of hops individual packets may traverse, and listening to responses of their expiry. It will regularly repeat this process, usually once per second, and keep track of the response times of the hops along the path. Path visualization is a visual representation of the data in a Visual Insight (VI) dashboard, such as a grid, line chart, or heat map. Visualizations provide a variety of ways for a user to display and interact with the data in the VI dashboard. In MTR's Path Visualization the routes/hops/node for any website from a Raspberry Pi3+device can be easily traced.

A first use case for the system is in hospitals. Fast and always reliable WiFi is critical for delivering great patient care. Hospitals that can troubleshoot, pinpoint and resolve WiFi issues quickly which empower caregivers to focus on patient outcomes, not connectivity. The system described herein bridges this gap between caregivers and IT. Patient outcomes depend on patient information capture and delivery between physicians, nurses and other caregivers on treatments. The NMS sensors continuously monitors (24/7) the WiFi network and the medical devices and sends notifications, the self-governing NEW platform eliminates helpdesk call-based trouble shooting. Disconnected, Intermittent connected devices cause patient safety issues. Going back to manual paper-based forms during outages or data corruption issues with enterprise devices can cause patient safety issues. Correct data is especially critical during care transitions where 88% of all serious medical errors occur. The NMS sensors installed at the client act as a continuously running utility to solve connection issues. Patient care and outcome is closely correlated to WiFi connectivity. Each patient within a hospital has on average 3-6 wireless devices attached to them to monitor various physiological parameters. If it takes a nurse between 5-15 minutes to visit each patient and check all vital signs, he or she can visit about 4-12 patients per hour. What happens if the connection is lost? Connected devices save time, increase quality of care and increase patient satisfaction. The NMS sensor-driven NEW system is the solution “Connected Hospitals” depend on for connectivity.

A second use case is on a school campus. Students, faculty and staff grow increasingly frustrated when they experience network delays and slow throughput because it hampers their ability to teach and learn. IT professionals react to these complaints and waste time and energy chasing down issues all over campus. The usual set of WLAN troubleshooting tools may help isolate and fix issues on a particular day, but do nothing to assure, track and proactively monitor the quality of the WiFi experience for students and faculty moving forward. When students come to campus, they expect WiFi to be ubiquitous. Gaming consoles, tablets, smart speakers, minifridges that text, Chromecast, Laptops, Tablets, and Phones—these are just some of the internet-connected items students are now bringing with them to their residence halls with so many WiFi enabled devices, colleges are struggling to keep up with students' expectation that wireless internet should be free, fast and everywhere. With such high demand for bandwidth, how can institutions avoid scenarios where students trying to work are slowed down by their neighbors playing video games. The NMS sensors help to Identify best and worst WiFi performing hours of the day, Pinpoint congestion and capacity issues, Stay ahead of complaints, Manage and maintain service levels, gives clear insights about Quick and Efficient way of On-boarding New Devices, devices struggling to get IP addresses, Reduce NW-Managers Workload Through Self-Service, Effectively Enforce/recommend Security Policies, and establishes Granular Visibility of their WLAN by asking (Who, What, Where, When, How). The NMS active sensors can be configured to run tests across sensors and other network hosts, automated tests can deliver real-time streaming data about network and application performance, enabling the system to detect problems even before the end-users do. The NMS sensor is a compact wireless device that lets you test real-world client experiences. The NMS sensor can be plugged into any electrical outlet. This provides the Sensor with high-fidelity insight at the ground level—where the majority of mobile devices are located. The NMS sensor is self-contained, compact unit utilizing Power over Ethernet (PoE) with 8 hrs battery backup and execute active testing, cyclic end-user synthetic test traffic (Layers 1-7), perform a comprehensive passive analysis (Layers 1-2) as well as 2.4 GHz and 5 GHz spectrum analysis. The tests are defined in a custom automated/on-demand, group-based test profile which can include communication with premises and cloud servers.

In VoWiFi networks, for example, it is desirable to monitor and measure network performance, and to anticipate problems before they occur. For example, the system may adopt a proactive approach to measure MOS, and generate traffic between two or more sensors and measure latency, jitter, packet loss, and other parameters. This enables early detection of VoIP quality degradation without waiting for a user to place a call and be affected. The following are exemplary data points that may be determined by the present system:
What is the average bandwidth consumption for one VoIP user across the interface?
How many concurrent VoIP sessions does one have per application across the interface?
What is the recommended number of concurrent sessions to configure by CPU? By RAM?
How many locations or address pairs (origin and destination) are in a concurrent VoIP session?
What is the latency associated with one user per VoIP application?
When are VoIP applications mostly used, during normal business hours or off peak?

The NMS sensor has a proactive approach to measure MOS, it can generate traffic between two or more sensors and measure latency, jitter, and packet loss. This enables early detection of VoIP quality degradation without waiting for a user to place a call and be affected.

The features of the present invention which are believed to be novel are set forth below with particularity in the appended claims. However, modifications, variations, and changes to the exemplary embodiments of the NEW platform and NMS sensors described above will be apparent to those skilled in the art, and the system and method described herein thus encompasses such modifications, variations, and changes and are not limited to the specific embodiments described herein.

What is claimed is:

1. A smart WiFi system comprising:
a smart sensor comprising:
a WiFi interface configured to communicate data via a WiFi network;
a LTE interface configured to communicate data via a LTE network;
an IP interface configured to communicate data via an IP network;
a fallback module configured to detect failure in one of the WiFi, LTE, and IP networks and switch data communication to a viable network;
an RF scanner configured to detect and identify RF signals in the surrounding environment for assessment of network quality and operating status;
a test logic module configured to administer a plurality of tests designed to test the operations of the networks and network components; and
a logging module configured to compile a record of received sensor data, network data, and network operating parameters and storing the data in a database; and
a smart analytic platform in communication with the smart sensor comprising:
a data analytic module configured to analyze network data to determine network operating parameters and issue early warning in response to network alarms; and
a dashboard module configured to present the sensor data, network data, data related to network operating parameters, and early warnings on a display screen.

2. The smart WiFi system of claim 1, further comprising an app docker.

3. The smart WiFi system of claim 1, wherein the smart sensor is configured to couple to an access point device via a USB interface.

4. The smart WiFi system of claim 3, wherein the smart sensor is configured to obtain power over multiple sources including Ethernet (PoE), a backup battery, and via the USB interface with the access point device.

5. The smart WiFi system of claim 1, wherein the RF scanner is configured to detect and receive data via multiple RF channels including at least one of WiFi, LTE, and IP channels.

6. The smart WiFi system of claim 1, wherein the RF scanner is configured to passively collect data transmitted via at least one of WiFi, BLE, and LTE channels for link quality monitoring and assessment.

7. The smart WiFi system of claim 1, wherein the smart analytic platform resides in a cloud-based computing device.

8. The smart WiFi system of claim 1, further comprising a GPS interface configured to receive GPS signals and extract an accurate clock signal therefrom for use by the smart sensor.

9. The smart WiFi system of claim 1, wherein the smart analytic platform further comprises a web browser-based graphical user interface.

10. A smart WiFi sensor comprising:
a WiFi interface configured to communicate data via a WiFi network;
a LTE interface configured to communicate data via a LTE network;
an IP interface configured to communicate data via an IP network;
a fallback module configured to detect failure in one of the WiFi, LTE, and IP networks and switch data communication to a viable network;
an RF scanner configured to detect and identify RF signals in the surrounding environment for assessment of network quality and operating status;
a test logic module configured to administer a plurality of tests designed to test the operations of the networks and network components; and
a logging module configured to compile a record of received sensor data, network data, and network operating parameters and storing the data in a database.

11. The smart WiFi sensor of claim 10, wherein the smart sensor is configured to communicate with a smart analytic platform that comprises:
a data analytic module configured to analyze network data to determine network operating parameters and issue early warning in response to network alarms; and
a dashboard module configured to present the sensor data, network data, data related to network operating parameters, and early warnings on a display screen.

12. The smart WiFi system of claim 10, wherein the smart sensor is configured to couple to an access point device via a USB interface.

13. The smart WiFi system of claim 12, wherein the smart sensor is configured to obtain power over multiple sources including Ethernet (PoE), a backup battery, and via the USB interface with the access point device.

14. The smart WiFi system of claim 10, wherein the RF scanner is configured to detect and receive data via multiple RF channels including at least one of WiFi, LTE, and IP channels.

15. The smart WiFi system of claim 10, wherein the RF scanner is configured to passively collect data transmitted via at least one of WiFi, BLE, and LTE channels for link quality monitoring and assessment.

16. The smart WiFi system of claim 10, further comprising a GPS interface configured to receive GPS signals and extract an accurate clock signal therefrom for use by the smart sensor.

17. The smart WiFi system of claim 11, wherein the smart analytic platform further comprises a web browser-based graphical user interface.

18. The smart WiFi system of claim 11, wherein the smart analytic platform resides in a cloud-based computing device.

19. A smart sensor for directly interfacing with an access point, the sensor comprising:
a communication interface configured to selectively communicate data via at least one of a plurality of wireless and wired communication channels;
a fallback module configured to detect failure in one of the plurality of communication channels and switch data communication to a viable communication channel;
an RF scanner configured to detect and identify RF signals in the surrounding environment for assessment of network quality and operating status;
a test logic module configured to administer a plurality of tests designed to test the operations of the networks and network components;
a logging module configured to compile a record of received sensor data, network data, and network operating parameters and storing the data in a database; and
wherein the smart sensor is configured to communicate with a smart analytic platform residing in a remote computing device.

20. The smart sensor of claim 19, further comprising:
A WiFi interface configured to communicate data via a WiFi network;
a LTE interface configured to communicate data via a LTE network; and
an IP interface configured to communicate data via an IP network.
